(19) United States
(12) Patent Application Publication
(10) Pub. No.: US 2022/0357718 A1
(43) Pub. Date: Nov. 10, 2022

(54) AUTOMATED CUSTOM FUNITURE DESIGN, MANUFACTURING, AND PACKAGING SYSTEM AND METHOD

(71) Applicant: Woodly Technology LLC, Pasadena, CA (US)

(72) Inventor: Behnam Akhondi, Pasadena, CA (US)

(21) Appl. No.: 17/736,427

(22) Filed: May 4, 2022

Related U.S. Application Data
(60) Provisional application No. 63/186,529, filed on May 10, 2021.

(51) Int. Cl. G05B 19/4099

(52) U.S. Cl. CPC G05B 19/4099; G05B 2219/35006

(57) ABSTRACT

An automated custom furniture design and manufacturing system is disclosed. The system includes a server configured to provide a user interface to a client, the user interface configured to receive user input for configuring custom furniture, the user input comprising dimension information of the custom furniture; and a custom furniture cutting machine in communication with the server and configured to receive a cutting list from the server, the cutting list is automatically generated based on the dimension information, the custom furniture cutting machine further configured to fabricate, based on the cutting list, pieces from which the custom furniture is assembled.

### CROSS-REFERENCE TO RELATED APPLICATION

This application claims priority to U.S. Provisional Patent Application Ser. No. 63/186,529, filed on May 10, 2021, the disclosure of which is hereby incorporated by reference in its entirety.

### FIELD

This relates to custom furniture, and, in particular, to an automated custom furniture design, manufacturing, and packaging system.

### BACKGROUND

Custom furniture is expensive, and it is not easy to find carpenter who will do exactly what the customer wants. There is no existing mechanism for a customer to custom design his furniture online without going back and forth with a small shop carpenter. Old school carpenters are expensive and working with one can be time-consuming. They also may not deliver the exact product that the customer wants.

### SUMMARY

In the embodiments of the disclosure, automated custom furniture design, manufacturing, and packaging system and method are disclosed. The system allows a customer to design his own custom furniture in a few simple steps that often take less than a minute using an online interface. The custom design is stored and automatically fed into an automated furniture cutting machine that can output, based on the custom design, ready-to-assemble furniture that can be assembled without any tools.

### BRIEF DESCRIPTION OF THE DRAWINGS

FIG. 1 is a block diagram illustrating the exemplary components of an automated custom furniture design, manufacturing, and packaging system, according to an embodiment of the disclosure.

FIG. 2 is an exemplary interface of the 3-D furniture design configurator, according to an embodiment of the disclosure.

FIG. 3 is a flow chart illustrating the exemplary steps of a custom furniture design, manufacturing, and packaging method, according to an embodiment of the disclosure.

FIGS. 4a-4c illustrates examples of two different designs of a custom shelf designed using the furniture design system, according to an embodiment of the disclosure.

FIG. 5 illustrates an exemplary shelf designed by the automated custom furniture design, manufacturing, and packaging system, indicating the individual pieces from which the shelf is assembled, according to an embodiment of the disclosure.

FIGS. 6a-6c illustrates the dimensions of exemplary pieces of the custom furniture, according to an embodiment of the disclosure.

FIGS. 7a-7i illustrates exemplary steps in assembling a piece of custom furniture designed using the embodiments of the systems and methods disclosed above in FIG. 1-6.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

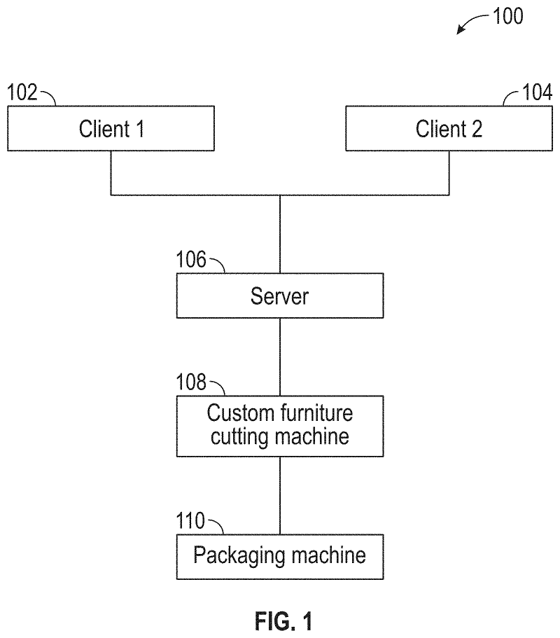

In one aspect of the disclosure, this relates to automated custom furniture design, manufacturing, and packaging systems and methods. FIG. 1 illustrates the exemplary components of an automated custom furniture design, manufacturing, and packaging system 100. The system includes one or more clients 102, 104, a server 106, a custom furniture cutting machine 108, and, optionally, a packaging machine 110. The server 106 can host a software program and database for providing a custom furniture configurator to the clients 102, 104. The program can display on the clients 102, 104 an interface (e.g., a webpage, an app) for a user to dynamically design and configure custom furniture.

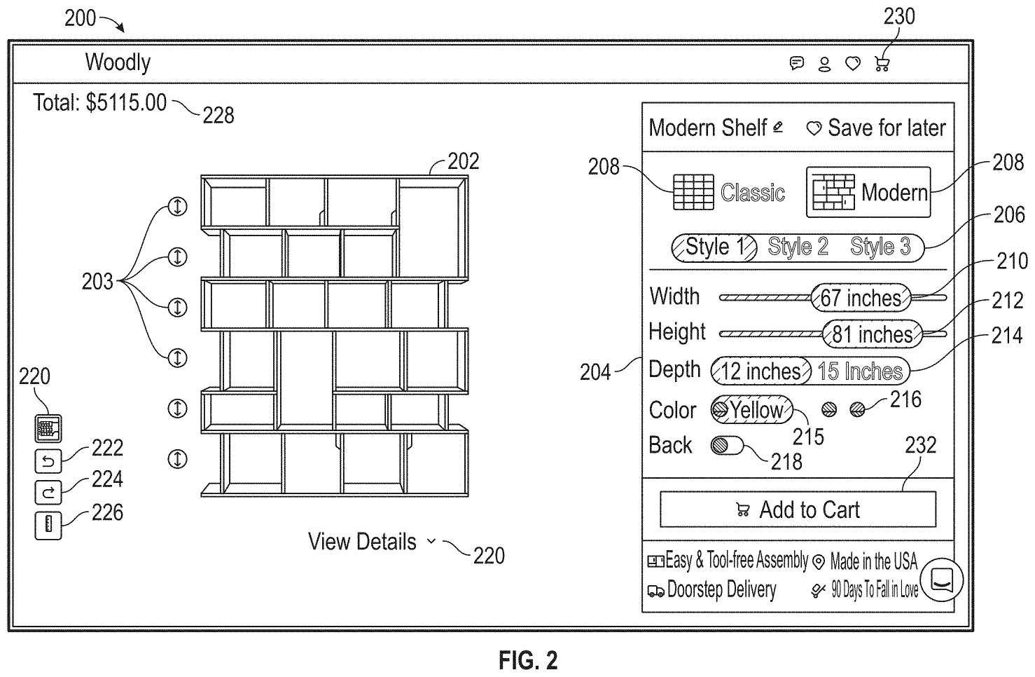

FIG. 2 illustrates an exemplary user interface 200 on a client. In this example, the user interface 200 is a webpage accessible via a web link. In other embodiments, the user interface 200 can be an app that is downloaded and runs on a smartphone or any other types of smart devices. The webpage 200 of FIG. 2 include a visual representation 202 of the custom furniture as it is being designed/configured by the user. In this example, the custom furniture is a multi-tiered shelf, but it should be understood that the custom furniture can be any other types of furniture suitable for modular configuration. The icons (collectively 203) on the left side of each tier of the shelf allow the user to adjust the height of the corresponding tier. For example, when the user clicks on (or touches on a touch screen) one of the icons, multiple preset heights can be displayed in a small window (not shown in FIG. 2) to allow the user to select one of the preset heights of the corresponding tier. Alternatively, clicking on or touching the icon can allow the user to manually enter a height for a particular tier of the shelf. These icons allow each tier of the shelf to be adjusted in its height, thus providing one way for the user the customize the shelf.

As shown in FIG. 2, a number of other adjustments can be made by using the options displayed in the menu 204 on the right side of the user interface 200. For example, menu 204 can allow the user to select one of three styles 206 of either a classic or modern shelf 208. The user can define the total width and height of the shelf using the roll bars 210, 212. When the width is increased beyond a threshold width, an additional block of the shelf can be automatically added in the width direction of the virtual representation of the shelf 202. Similarly, when the width is decreased to less than a threshold width, one of the blocks is automatically removed in the width direction of the shelf. The height adjustment 212 works in a similar fashion in that an additional tier is added when the height is increased over a threshold height and an existing tier of the shelf is automatically removed from the virtual representation of the shelf 202 when the height is automatically reduced to below a threshold height.

In addition, the user can choose one of two depths 214, one of several colors 215 of the selected color for the custom shelf 202. The “Back” switch 218 allows the user to choose to either add a back panel to the shelf or have a backless shelf. In this embodiment, when the user is trying out the different settings in the menu 204, the virtual shelf 202 can adjust automatically to show the actual look of the shelf based on the selected settings. This allows the user to visualize the furniture as he is designing it, which would make the design process both intuitive and fun. It should be understood that the design options offered on the user interface 200 including those in the menu 204 can be different from those shown in FIG. 2. Some of the menu options illustrated in FIG. 2 may not be offered for certain types of furniture while additional menu options can be added for other types.

The user interface 200 can also include a “view in detail” option 220, which shows the furniture in a real-world like setting (e.g., a living room background and with objects placed on the shelf). The optional undo and redo icons 222, 224 provide a quick way of moving back and forth between design changes. The ruler icon 226, when clicked on or touched can superimpose the dimensions of the shelf including, for example, those of each tier and block on the virtual representation 202. The total price 228 of the custom furniture is shown at the left top corner of the user interface 200. The total price 228 is dynamically updated as the user experiments with the different configurations. For example, adding another tier or increase the size of the shelf would increase the total price 228 and vice versa.

When the user is happy with the design shown on the user interface 200, he can click the “Add to Cart” button 232 to save the design in the shopping cart 230. The user can then start a new design of a different piece of furniture or go to the shopping cart 230 to complete the purchase of his custom furniture.

Although the furniture shown in the user interface 200 of FIG. 2 is a shelf, it should be understood that the same or a similar user interface can be used to design and/or configure desks, chairs, couches, tables, bookshelves, bookcases, sideboards, storages, and any other types of home or office furniture.

Referring back to FIG. 1, once the user completes an order via the user interface 200 of FIG. 2. The order information is transmitted from the client 102 (e.g., user's computer or smartphone) to the server 100. It should be understood that, although only two clients 102, 104 are illustrated in FIG. 1, any number of clients can be connected to the server 100. The server 100 can store the order information in a database and automatically generate the dimension information of the various pieces (e.g., doors, end boards, horizontal boards, and back panels) from which the custom furniture can be assembled.

The server 100 can then process the user's custom furniture order to create and transmit a cutting list including, for example, the dimension information of the furniture to the custom furniture cutting machine 108. The custom furniture cutting machine 108 can automatically produce the unassembled furniture pieces based on the dimension information of each piece. Because the server 100 and the custom furniture cutting machine 108 are in electron communication with each other, no manual input is required to transfer the dimension information or any other information related to the custom design from the server 100 to the custom furniture cutting machines 108. The custom furniture cutting machine 108 can be a CNC wood machine (or any other type of wood-carving machines) that is designed to carve wood into pieces of specific sizes. After all the pieces for the custom furniture is prepared by the custom furniture cutting machine 108, the pieces can be packaged by a packaging machine 110 in a package customized based on the dimensions of the pieces using the dimension information from the server 106. The packaging machine 110 can be designed to create custom packaging dimensions based on the dimensions of the pieces.

Each of clients 102, 104, server 106, customer furniture cutting machine 108, and packaging machine 110 can be in communicate with each other over either a wired or wireless network such as, but not limited to the internet, a local area network, a wide area network, a cellular network, WiFi network, and a virtual private network.

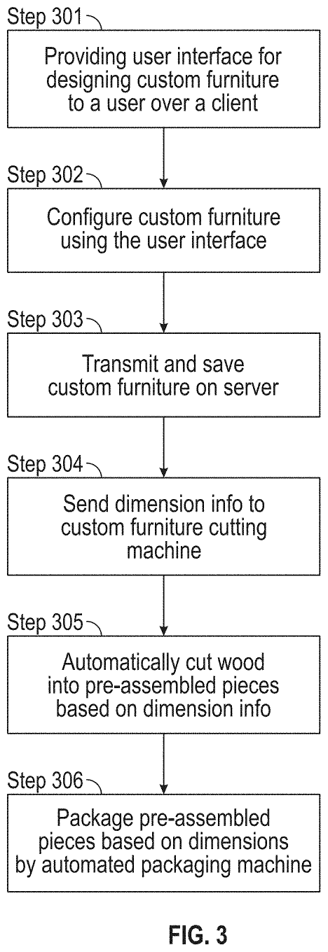

FIG. 3 is a flowchart illustrating the exemplary steps of a custom furniture design, manufacturing, and packaging method, according to an embodiment of the disclosure. First, a user interface (e.g., the user interface 202 of FIG. 2) for designing and/or configuring custom furniture is provided to the user over a client (step 301). The user can use the user interface to configure a custom piece of furniture (step 302). Upon completion, the custom furniture design can be transmitted and saved on a server (step 303). The server can then send dimension information relating to the user-designed custom furniture to a custom furniture cutting machine (step 304), which, in turn, can automatically cut wood into pre-assembled pieces of the furniture based on the dimension information (step 305). Finally, the pre-assembled pieces can be packaged based on their dimensions by an automated packaging machine (step 306).

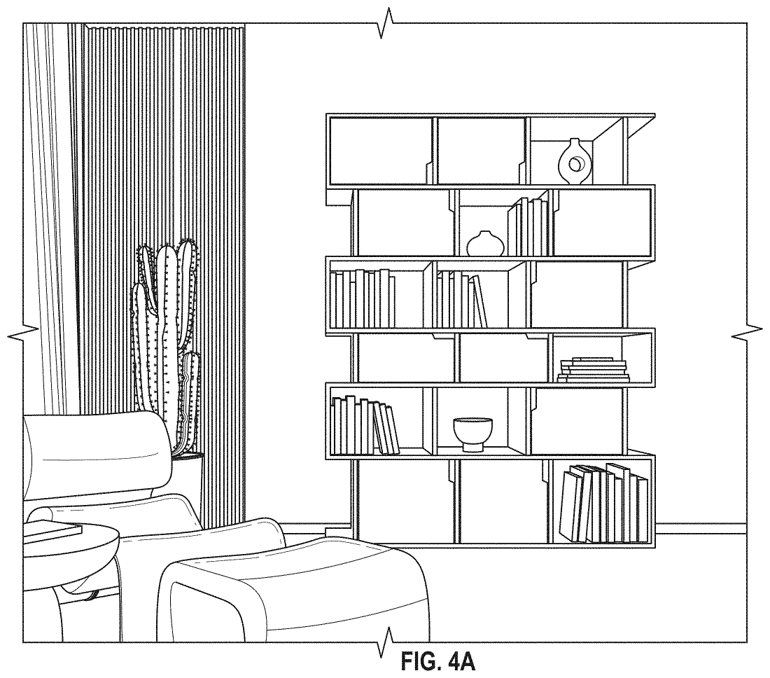

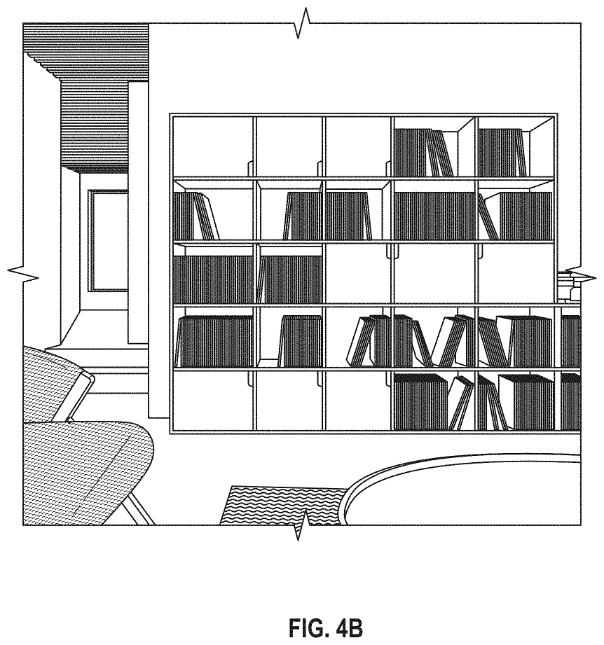

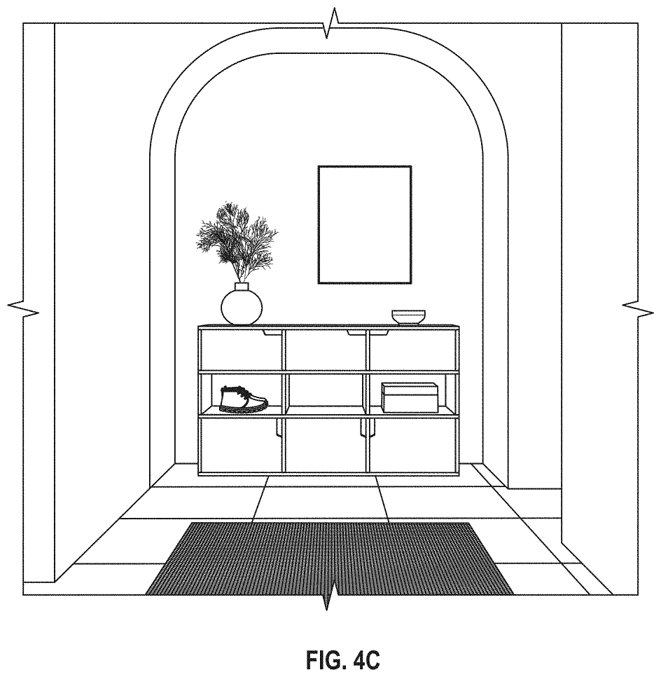

FIGS. 4a-4c illustrates examples of three different designs of a custom shelf designed using the furniture design system, according to an embodiment of the disclosure. The design of FIG. 4a corresponds to the modern style shelf in the menu 204 of FIG. 2. The design of FIG. 4b corresponds to the classic style shelf in the menu 204 of FIG. 2. FIG. 4c corresponds to another classic style shelf with different dimensions. In one embodiment, to achieve the different styles and/or dimensions, ¾″ birch plywood with exposed edge can be used. The shelves can be constructed with one-piece horizontal pieces and separated vertical pieces with optional additional supports based on each individual design.

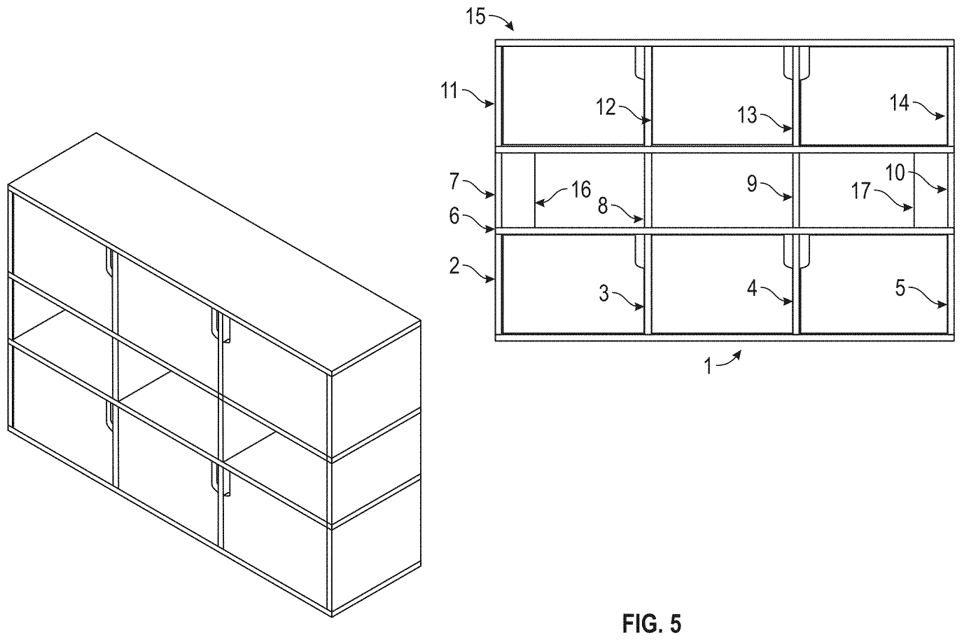

FIG. 5 illustrates an exemplary shelf designed by the automated custom furniture design, manufacturing, and packaging system, indicating the individual pieces from which the shelf is assembled, according to an embodiment of the disclosure. The shelf of FIG. 5 can include a total of 17 pieces (numbered 1-17) that can be automatically fabricated by the custom furniture cutting machine based on dimensions from the user's design.

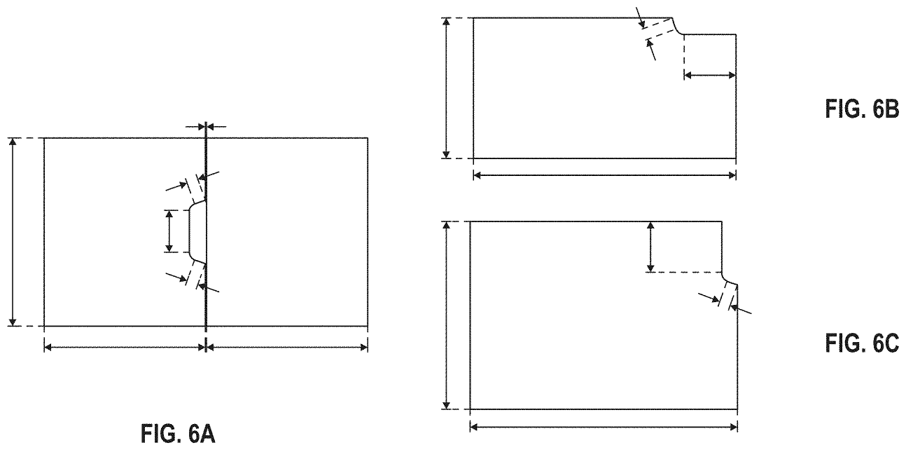

FIGS. 6a-6c illustrates the dimensions of exemplary pieces of the custom furniture, according to an embodiment of the disclosure. In particular, FIG. 6a illustrates the dimensions of a double door. FIG. 6b illustrates the dimensions of a drawer front. FIG. 6c illustrates the dimensions of a door. These dimension information can be captured from the user interface upon the finalization of the custom configuration and then provided to the automated custom furniture cutting machine to be used for fabricating the individual pieces. Again, this process from when the order of the custom furniture is submitted to the server to when the pieces are fabricated (or even packaged) is completely automatic and without requiring any manual steps.

The above-described embodiments allow a user to design his own furniture under a minute with the disclosed high-tech 3D configurator online. The user can design his furniture inch-by-inch online, with options such as different sizes and different colors. These embodiments of the disclosure are better than any existing custom furniture design and manufacturing system simply because no similar alternative exists. They fill a need because not all customers are furniture designers and not all carpenters understand what the customer needs. The methods disclosed in the above embodiments are inexpensive and not time consuming. They allow a user to design his own custom furniture in less than a minute online and order it while he is sitting on his couch watching a TV show.

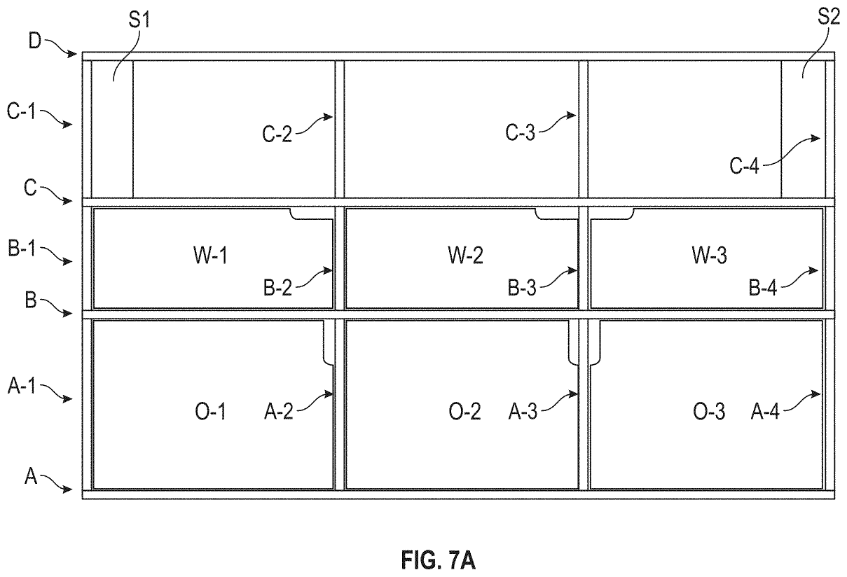

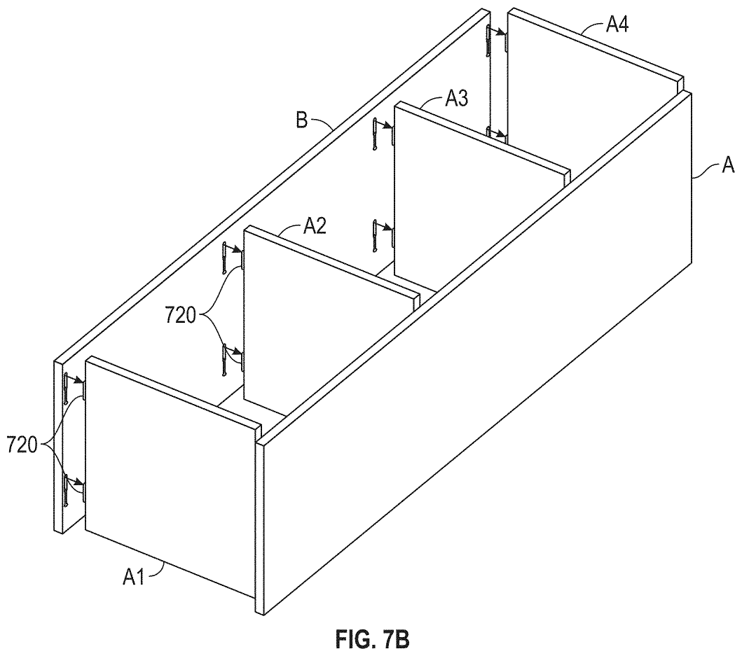

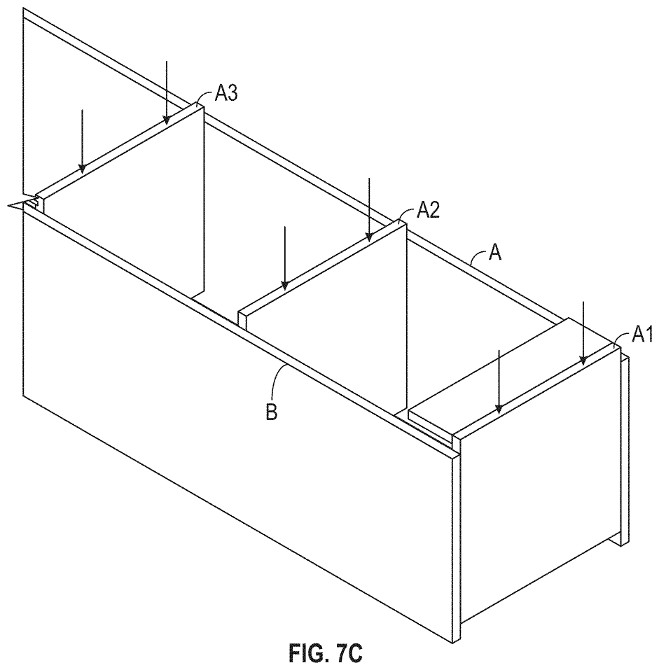

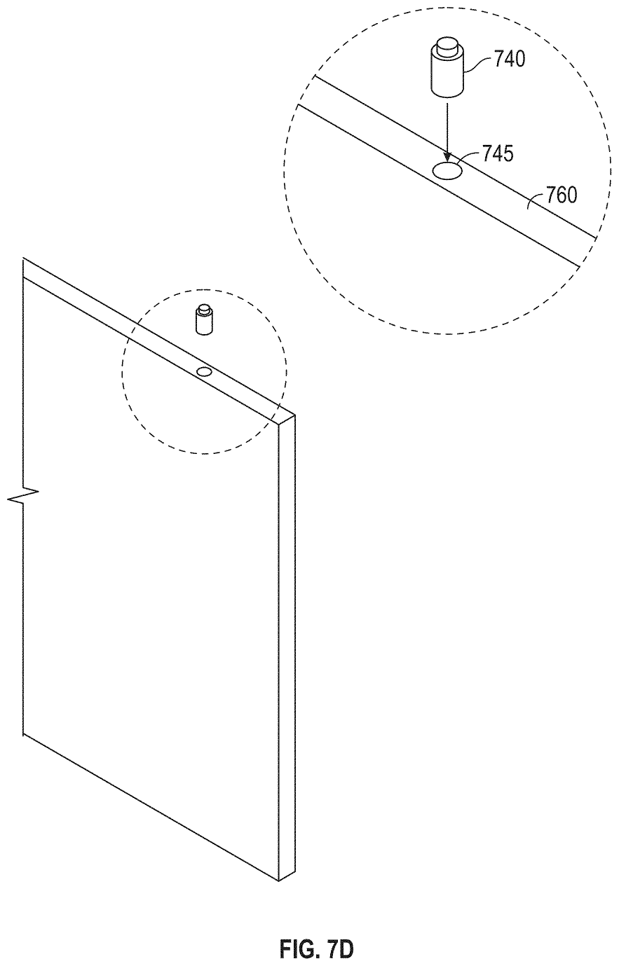

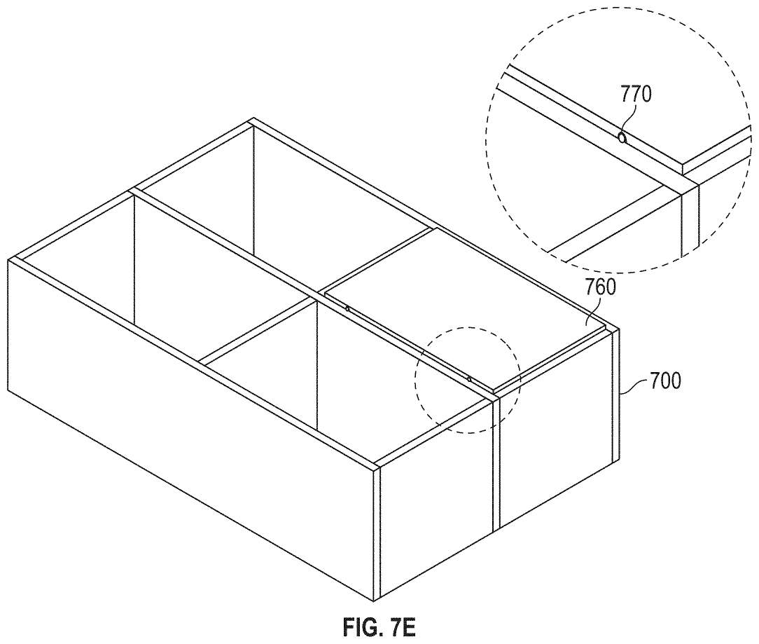

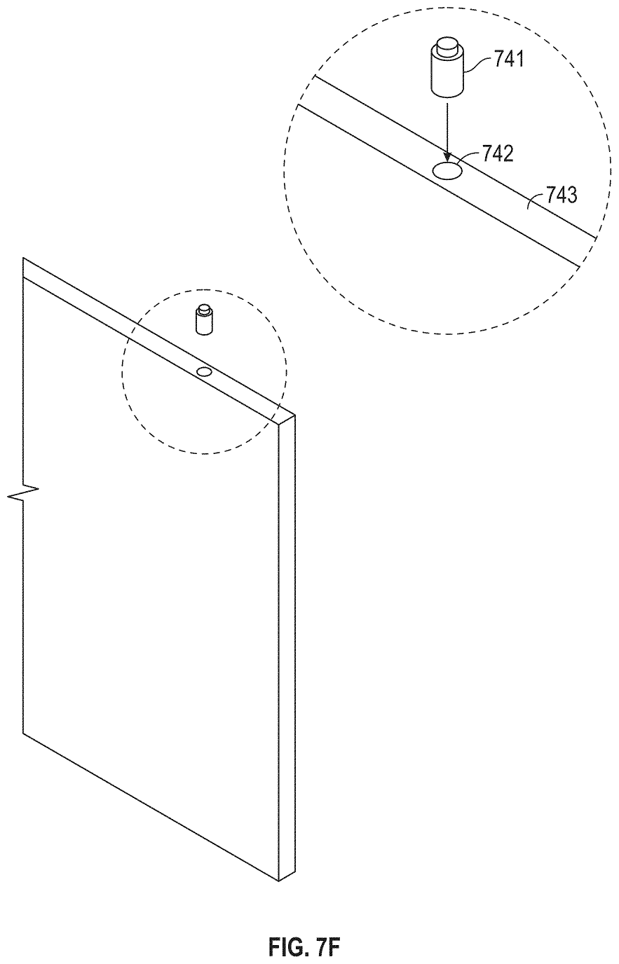

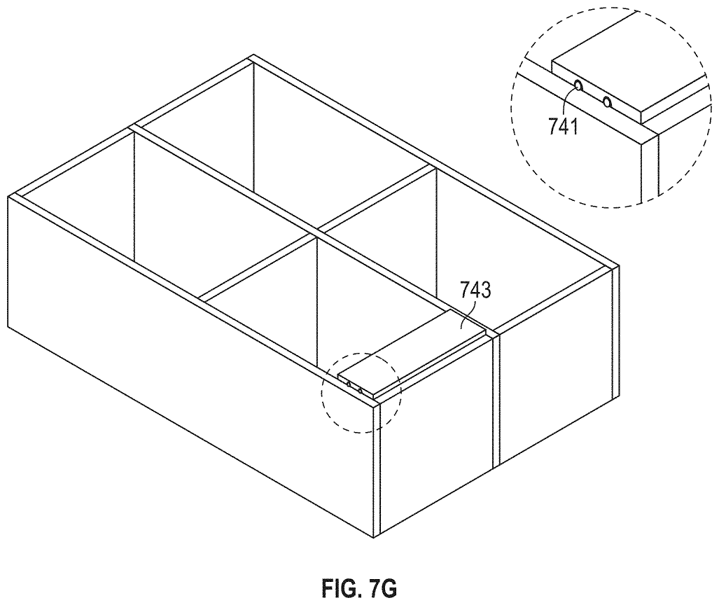

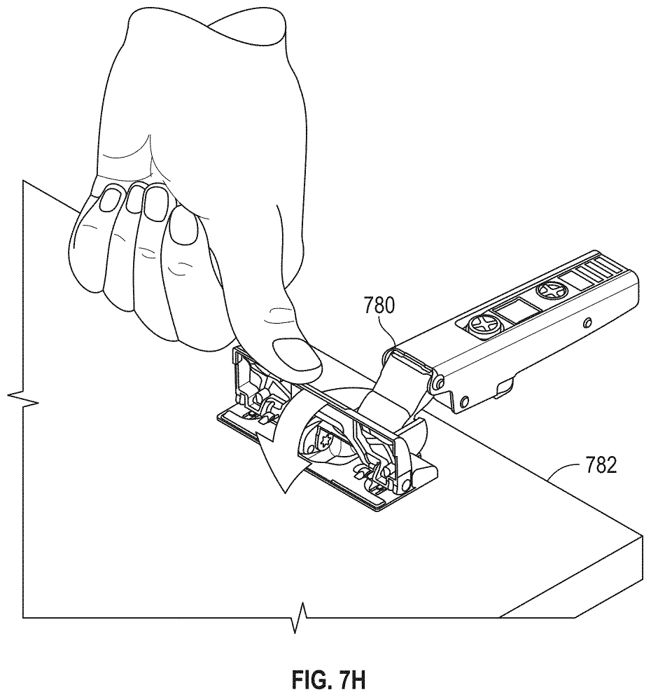

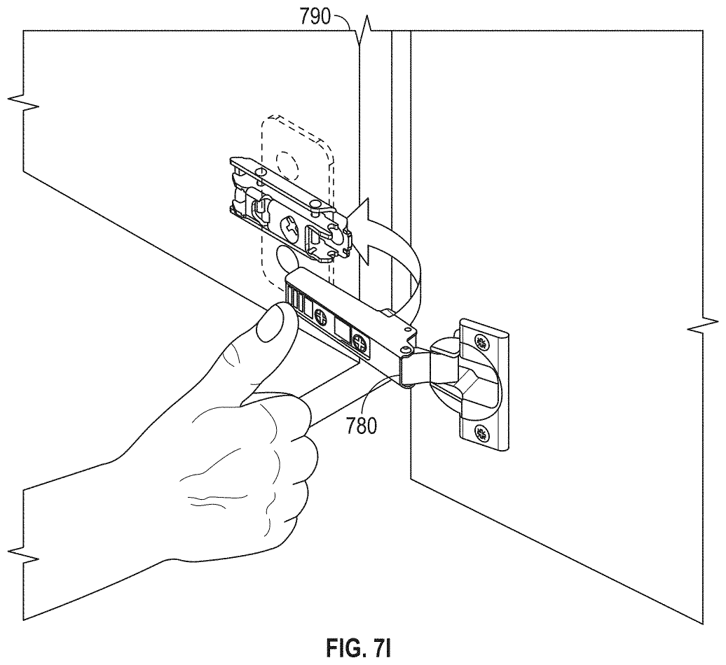

In another aspect of the disclosure, the custom furniture is designed such that assembly does not require any tools and the assembly process is easy and fun. The furniture can be easily disassembled for a move. FIGS. 7a-7i illustrates exemplary instructions for assembling a piece of custom furniture designed using the embodiments of the systems and methods disclosed above.

FIG. 7a illustrates an assembled shelf 700. The assembled shelf 700 includes horizontal A, B, C, D pieces, vertical A1-A4, B1-B4, C1-C4 pieces, back panels O1-O3, W1-W3, and support pieces S1, S2.

FIG. 7b-7i illustrates the exemplary assembly steps of the shelf 700 of FIG. 7a. First, verticals A1-A4 are inserted into the horizontal A without push the verticals down. Second, as illustrated in FIG. 7b, horizontal B is inserted into the connectors (collectively 720) on the verticals A1-A4 while keeping the verticals A1-A4 at a higher level than the horizontal B. Third, push all the verticals A1-A4 down gently until all of them are flush with the horizontal pieces A and B, as illustrated in FIG. 7c. The first three steps are then repeated for the rest of the shelves.

Once the horizontal and vertical pieces of the shelf is assembled, 4 pins 740 can be inserted into respective holes 750 on the back panels 760, as illustrated in FIG. 7d. Although only one pin and one hole is illustrated in FIG. 7d, it should be understood that the back panels can have any number of pins and holes. Then, each back panel 760 can be placed on the designated location, covering a portion of the back of the shelf 700. The spring pins 770 are pushed in and the back panel 760 is pushed down, as illustrated in FIG. 7e.

Next, 4 pins 741 can be inserted into respective holes 742 on the support pieces 743, as illustrated in FIG. 7f. The support pieces 743 can then be placed on designated locations and the spring pins 741 can be pushed in and push the support pieces 743 down, as illustrated in FIG. 7g.

If the shelf comes with doors, a hinge top 780 can be clipped onto the door 782, as illustrated in FIG. 7h. The hinge 780 can be inserted into the front of the base 790 and the back of the hinge 780 can be pushed into the base 790. A click sound can indicate that the hinge is locked in and secured.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A computer-implemented method of designing and manufacturing custom furniture comprising:
providing an online user interface configured to receive user input for configuring custom furniture, the user input comprising dimension information of the custom furniture;
automatically generating a cutting list based on the dimension information; and
transmitting the cutting list to a custom furniture cutting machine to fabricate pieces from which the custom furniture is assembled.

2. The computer-implemented method of claim 1, wherein the custom furniture cutting machine is a CNC word cutting machine.

3. The computer-implemented method of claim 2, wherein the dimension information comprises a width, height, and depth of each of the pieces from which the custom furniture is assembled.

4. The computer-implemented method of claim 1, wherein the custom furniture cutting machine is configured to receive the cutting list and fabricate the pieces without any human intervention.

5. The computer-implemented method of claim 1, wherein the user interface comprises a web interface or a mobile app interface.

6. The computer-implemented method of claim 1, wherein the user interface is displayed on a client.

7. The computer-implemented method of claim 1, wherein the user interface comprises menu items including one or more of a furniture type selector, a furniture style selector, a width field, a height field, a depth field, a color selector, and a backboard selector.

8. The computer-implemented method of claim 7, wherein the user interface comprises a visual representation of the custom furniture.

9. The computer-implemented method of claim 8, wherein the visual representation of the custom furniture is three-dimensional.

10. The computer-implemented method of claim 8, wherein the visual representation of the custom furniture is dynamically updated in response to a user adjustment of at least one of the menu items.

11. The computer-implemented method of claim 8, wherein the visual representation comprises one or more built-in height adjustment icons, each controlling the height of a tier of the custom furniture.

12. The computer-implemented method of claim 7, wherein the user interface comprises a total price field showing a total price of the custom furniture.

13. The computer-implemented method of claim 8, wherein the total price field is automatically updated in response to a user adjustment of at least one of the menu items.

14. An automated custom furniture design and manufacturing system:
a server configured to provide a user interface to a client, the user interface configured to receive user input for configuring custom furniture, the user input comprising dimension information of the custom furniture; and
a custom furniture cutting machine in communication with the server and configured to receive a cutting list from the server, the cutting list is automatically generated based on the dimension information, the custom furniture cutting machine further configured to fabricate, based on the cutting list, pieces from which the custom furniture is assembled.

15. The automated custom furniture design and manufacturing system of claim 14, further comprising an automated packaging machine in communication with the custom furniture cutting machine, the automated packaging machine configured to automatically design a packaging for the pieces fabricated by the custom furniture cutting machine.

16. The automated custom furniture design and manufacturing system of claim 15, wherein the packaging is of custom dimensions generated based on the cutting list.

17. The automated custom furniture design and manufacturing system of claim 14, wherein the server, the custom furniture cutting machine, and the automated packaging machine are connected via a wireless network.

18. The automated packaging machine of claim 14, wherein the custom furniture cutting machine is a CNC word cutting machine.

19. The automated packaging machine of claim 14, wherein the custom furniture cutting machine is configured to receive the cutting list and fabricate the pieces without any human intervention.

20. The automated packaging machine of claim 14,
wherein the user interface comprises a web interface or a mobile app interface;
wherein the user interface is displayed on a client;
wherein the user interface comprises menu items including one or more of a furniture type selector, a furniture style selector, a width field, a height field, a depth field, a color selector, and a backboard selector;
wherein the user interface comprises a visual representation of the custom furniture;
wherein the visual representation of the custom furniture is three-dimensional;
wherein the visual representation of the custom furniture is dynamically updated in response to a user adjustment of at least one of the menu items;
wherein the visual representation comprises one or more built-in height adjustment icons, each controlling the height of a tier of the custom furniture;
wherein the user interface comprises a total price field showing a total price of the custom furniture; and
wherein the total price field is automatically updated in response to a user adjustment of at least one of the menu items.
